(19) United States
(12) Patent Application Publication
(10) Pub. No.: US 2005/0114638 A1
(43) Pub. Date: May 26, 2005

(54) Hardware assisted assembly code debugging

(76) Inventor: Ernest P. Chen, Gilbert, AZ (US)

Correspondence Address: INTEL CORPORATION, P.O. BOX 5326, SANTA CLARA, CA, 95056-5326, US

(21) Appl. No.: 10/723,051

(22) Filed: Nov. 25, 2003

(51) Int. Cl. G06F 9/00

(52) U.S. Cl. 712/244

(57) ABSTRACT

An embodiment for hardware assisted assembly code debugging uses configurable data bits to enable breakpoint and single-stepping debugging. One of the data bits is included in the data bits defining a computer program instruction op-code and is configurable to halt execution of the instruction by a processing element. Other of the data bits are held in a control register coupled to the processing element and are configurable to halt both execution of individual instructions and to consecutively halt execution of multiple instructions.

### BACKGROUND

Compiling of computer software code from human recognizable mnemonics form into computer processor recognizable assembly code form typically requires debugging of the compiled code. Traditional debugging is an inefficient process requiring significant effort on the part of the programmer to properly manipulate the “debugger” application software. The typical debugger works by altering (over-writing) the code to insert “breakpoint” instructions designating points in the code stream where code execution is to be halted. For example, debuggers compatible with x86 processors insert soft interrupt instructions (INT3) to indicate code breakpoints. Halting program execution using breakpoints enables the programmer to examine the state of code variables at specific points in the program flow. However, inserting breakpoints into the code alters the normal code flow sequence disrupting inter-instruction timing and data dependencies. Compensating for these effects adds to the complexity of the debug process. Moreover, programmers may wish to insert a breakpoint before each instruction so that the debugger “single-steps” through the code. Traditional x86 debuggers single-step by simulating the current halted instruction to determine where the next instruction occurs and hence where to insert a next INT3 breakpoint. This simulation process becomes particularly complex when the current instruction results in a program flow change through looping, branching or subroutine calls.

### BRIEF DESCRIPTION OF THE DRAWINGS

Embodiments of the invention may be best understood by referring to the following description and accompanying drawings which illustrate such embodiments. The numbering scheme for the Figures included herein are such that the leading number for a given reference number in a Figure is associated with the number of the Figure. For example, a system 100 can be located in FIG. 1. However, reference numbers are the same for those elements that are the same across different Figures. In the drawings:

FIG. 1 illustrates an embodiment of a system for hardware assisted assembly code debugging in a processor.

FIG. 2 illustrates a more detailed block diagram of an embodiment of the media processor of FIG. 1.

FIG. 3 illustrates in more detailed block diagram form an embodiment of the RAM and control register of FIG. 2.

FIG. 4 illustrates a flow diagram of an embodiment for providing hardware assisted assembly code debugging.

FIG. 5 illustrates a flow diagram representing an embodiment of an implementation by a debugger program of breakpoint hardware assisted assembly code debugging using global halt control.

FIG. 6 illustrates a flow diagram representing an embodiment of an implementation by a debugger program of instruction specific breakpoint hardware assisted assembly code debugging.

FIG. 7 illustrates a flow diagram representing an embodiment of an implementation by a debugger program of single-step hardware assisted assembly code debugging.

### DETAILED DESCRIPTION

Methods, apparatuses and systems for hardware assisted assembly code debugging are described. In the following description, numerous specific details such as logic implementations, op-codes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that embodiments of the invention may be practiced without such specific details. In other instances, control structures, gate level circuits and full software instruction sequences have not been shown in detail in order not to obscure the embodiments of the invention. Those of ordinary skill in the art, with the included descriptions will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Embodiments of the invention include features, methods or processes embodied within machine-executable instructions provided by a machine-readable medium. A machine-readable medium includes any mechanism which provides (i.e., stores and/or transmits) information in a form accessible by a machine (e.g., a computer, a network device, a personal digital assistant, manufacturing tool, any device with a set of one or more processors, etc.). In an exemplary embodiment, a machine-readable medium includes volatile and/or non-volatile media (e.g., read only memory (ROM), random access memory (RAM), magnetic disk storage media, optical storage media, flash memory devices, etc.), as well as electrical, optical, acoustical or other forms of propagated signals (e.g., carrier waves, infrared signals, digital signals, etc.)).

Such instructions are utilized to cause a general, special purpose processor or other form of embedded logic programmed with the instructions, to perform methods or processes of the embodiments of the invention. Alternatively, the features or operations of embodiments of the invention are performed by specific hardware components which contain hard-wired logic for performing the operations, or by any combination of programmed data processing components and specific hardware components. Embodiments of the invention include software, data processing hardware, data processing system-implemented methods, and various processing operations, further described herein.

A number of figures show block diagrams of systems and apparatus for hardware assisted assembly code debugging, in accordance with embodiments of the invention. A number of figures show flow diagrams illustrating operations for hardware assisted assembly code debugging. The operations of the flow diagrams will be described with references to the systems/apparatus shown in the block diagrams. However, it should be understood that the operations of the flow diagrams could be performed by embodiments of systems and apparatus other than those discussed with reference to the block diagrams, and embodiments discussed with reference to the systems/apparatus could perform operations different than those discussed with reference to the flow diagrams.

### Processor System

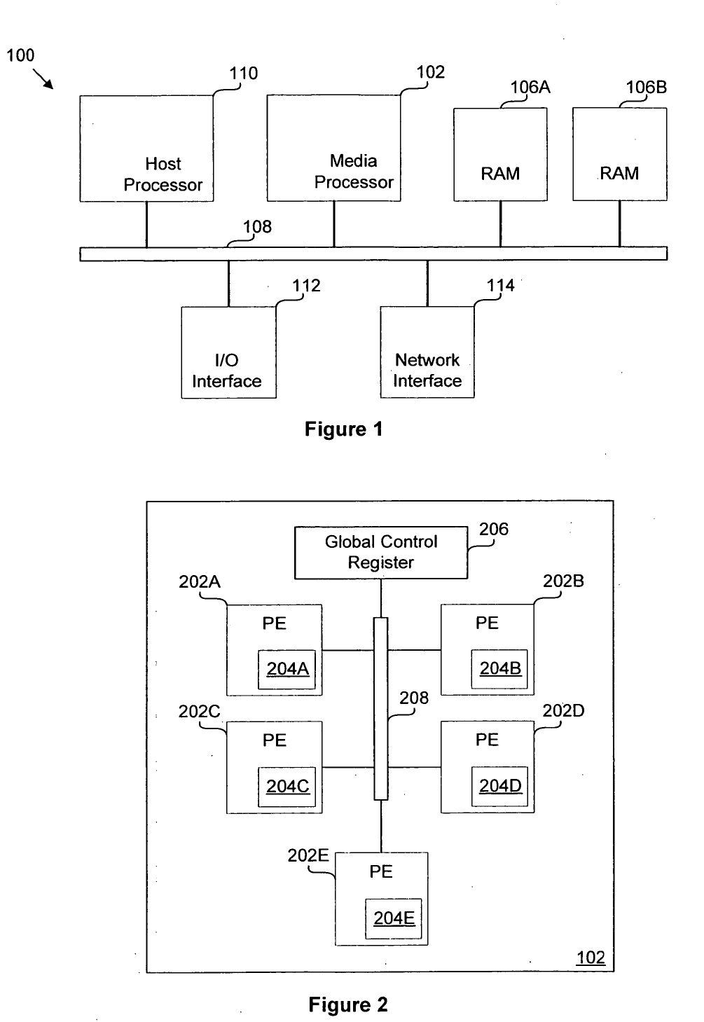

FIG. 1 illustrates an embodiment of a processor system 100 for hardware assisted assembly code debugging, according to one embodiment of the invention. System 100 includes a media processor 102 for processing media data such as image data, for example. Media processor 102 is also coupled to memories 106A-106B. In an embodiment, the memories 106A-106B may be different types of Random Access Memory (RAM). For example, memories 106A-106B are Double Data Rate (DDR) Synchronous Dynamic RAM (SDRAM). In, addition, media processor 102 is coupled to a bus 108, which in an embodiment, may be a Peripheral Component Interface (PCI) bus. System 100 also includes a host processor 110, a number of input/output (I/O) interfaces 112 and a network interface 114. Host processor 110 is coupled to memories 106A-106B. I/O interface 112 provides an interface to I/O devices or peripheral components for the system 100. I/O interface 112 may comprise any suitable interface controllers to provide for any suitable communication link to different components of the system 100. In one embodiment, I/O interface 112 provides suitable arbitration and buffering for one of a number of interfaces.

For one embodiment, I/O interface 112 provides an interface to one or more suitable integrated drive electronics (IDE) drives, such as a hard disk drive (HDD) or compact disc read only memory (CD ROM) drive for example, to store data and/or instructions, for example, one or more suitable universal serial bus (USB) devices through one or more USB ports, an audio coder/decoder (codec), and a modem codec. I/O interface 112, for one embodiment, also provides an interface to a keyboard, a mouse, and one or more suitable devices, such as a printer for example, through one or more ports. Network interface 114 provides an interface to one or more remote devices over one of a number of communication networks (the Internet, an Intranet network, an Ethernet-based network, etc.).

Host processor 108, I/O interfaces 112 and network interface 114 are coupled to media processor 102 through bus 108. As will be further described below, instructions executing within the host processor 110 configure media processor 102 for different methods of assembly code debugging. For example, host processor 110 configures a number of debug control data bits associated with different processor elements within media processor 102. Further, host processor 108 downloads microcode configured to enable debugging of the different processor elements within media processor 102. To illustrate, a more detailed description of one embodiment of the media processor 102 will now be provided.

FIG. 2 illustrates a more detailed block diagram of an embodiment of media processor 102 of FIG. 1. As shown, media processor 102 includes a set of parallel processing elements (PE) 202A-202E, each PE containing an embedded RAM 204A-204E, a global control register 206 and an internal bus 208 coupling processing elements 202A-202E to register 206. In accordance with one embodiment of the invention, PEs 202A-202E process image data in response to instruction microcode (or op-code) stored in embedded RAM 204A-204E. In accordance with an embodiment of the invention, PEs 202A-202E process image data in response to control data bits stored in control register 206.

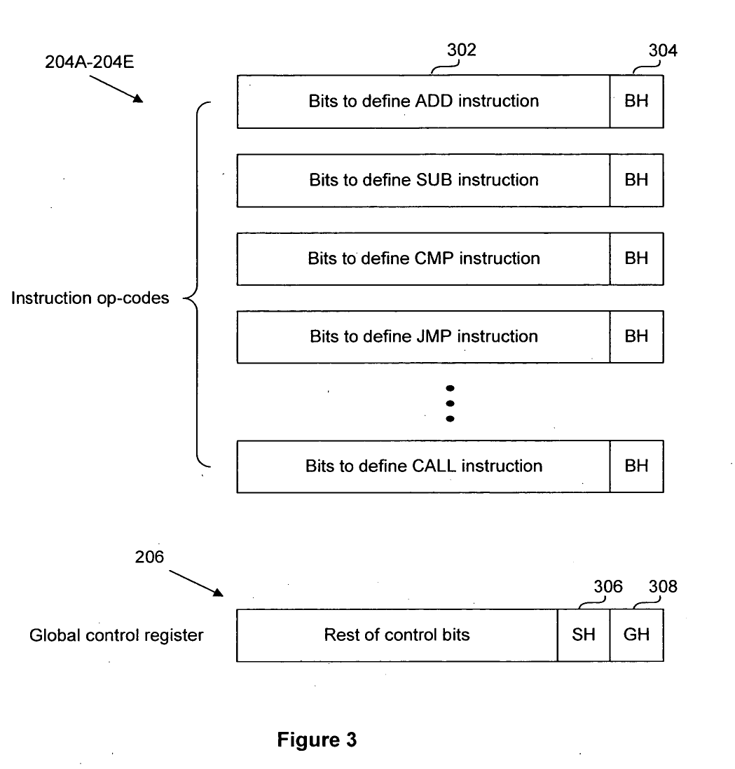

FIG. 3 illustrates in more detailed block diagram form the RAM 204A-204E and control register 206 of FIG. 2. Each op-code 302 stored in RAM 204A-204E, in accordance with an embodiment of the invention, includes a Breakpoint Halt (BH) control data bit 304 as one of the set of data bits defining the op-code's instruction. For example, although the invention is not limited in this respect, each op-code comprises a total of 32 data bits wherein the BH bit is the 32^{nd} and last data bit. When set the BH bit 304 indicates that execution of the associated op-code is to be halted. Moreover, in accordance with an embodiment of the invention, register 206 contains at least two control data bits, a Step Halt (SH) bit 306 and a Global Halt (GH) bit 308 although the invention is not limited in this respect. As will be described in more detail below, the BH, SH and GH data bits are configurable such that computer program instructions stored as op-codes 302 and executed by PEs 202A-202E can be allowed to execute or can be halted both individually and sequentially to enable both breakpoint and single-stepping assembly code debugging.

Although FIGS. 1-3 describe embodiments wherein assembly code debugging is indicated by data bits contained in either registers or as part of an op-code instruction, the invention is not limited to these embodiments. For example, in accordance with the invention, hardware assisted assembly code debugging may be enabled using any appropriate indicator which may include, but are not limited to, data bits held in one or more registers, data bits held in one or more memories, data bits contained in op-code instructions, or logic levels asserted on one or more control signal lines, to name only a few examples. Moreover, the invention is not limited to hardware assisted debugging of assembly code executed by a media processor as shown in the embodiment of FIG. 1. For example, the invention may include embodiments wherein hardware assisted debugging is enabled for assembly code executed by, for example, a Pentium™ processor, a Field Programmable Gate Array (FPGA) or any other embedded logic capable of executing assembly language program instructions.

### Assembly Code Debugging

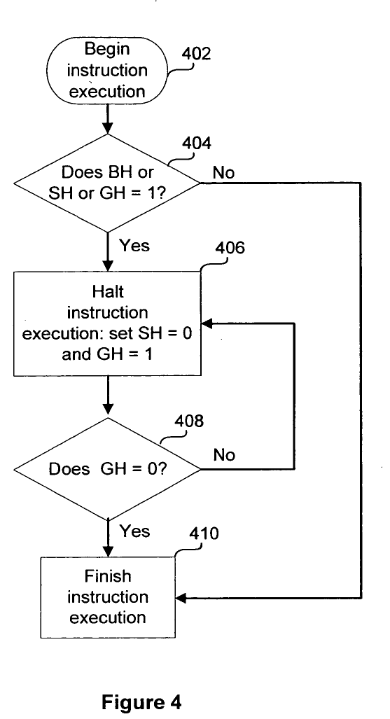

FIG. 4 illustrates a flow diagram for providing hardware assisted assembly code debugging, in accordance with an embodiment of the invention.

Referring to FIGS. 1-4, in block 402 of FIG. 4, one of PEs 202A-202E, PE 202A, for example, begins execution of a computer program instruction op-code 302 stored in RAM 204A. The op-code may define, for example, although the invention is not limited in this respect, one of ADD, SUB or other arithmetic operations to be performed by PE 202A on, for example, image data. In block 404, PE 202A responds to either BH, SH or GH being set equal to a logical one by halting the execution of the current instruction and proceeding to block 406. If none of bits BH, SH or GH are set equal to one then PE 202A finishes execution of the instruction at block 410. It should be noted, however, that the embodiments of the invention are not limited by the manner in which bits BH, SH and GH are defined logically. In other words, and in accordance with the invention, bits BH, SH and GH can be defined such that any one of the bits being set corresponds to a logical zero or to a logical one and in being so set directs PE 202A to halt execution of the instruction in block 404. Returning to the embodiment of FIG. 4, in block 406, PE 202A halts execution of the instruction by setting SH equal to zero and GH equal to one. Halting the instruction in this manner corresponds to a program debug breakpoint and enables a programmer debugging the software code stored in RAM 204A to inspect program variables at that a point in the program flow immediately prior to the halted instruction.

In block 408, PE 202A responds to be GH being reset to equal zero by proceeding to block 410 and finishing execution of the instruction. As long as GH remains equal to one, PE 202A continues to halt execution of the instruction and remains at block 406. Once GH is set equal to zero and execution of the current instruction in completed at block 410, PE 202A continues the program flow by loading the next op-code 302 stored in RAM 204A. In this manner the invention enables global hardware control and/or instruction specific control of breakpoint assembly code debugging.

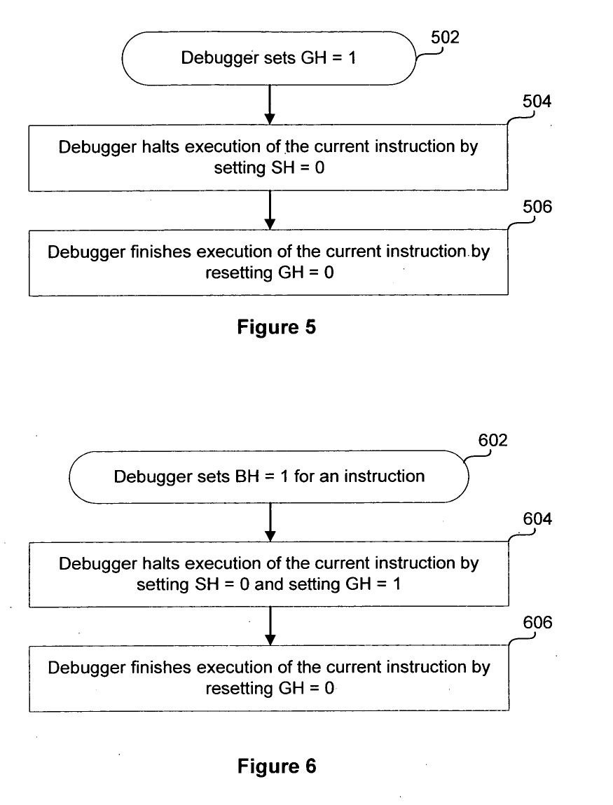

FIG. 5 illustrates a flow diagram representing implementation by a debugger program of hardware assisted assembly code debugging using global halt control, in accordance with an embodiment of the invention. In accordance with one embodiment of the invention, although the invention is not limited in this respect, and referring to FIGS. 1-3, the debugger program is run from host processor 110 using program instructions loaded from an HDD and stored in memories 106A-106B where the HHD is coupled to system 100 through I/O interface 112. The debugger enables a programmer using breakpoint and single-stepping techniques to debug, a computer program stored as op-code instructions 302 in RAM 204A and to be executed by PE 202A for example. In the embodiment of FIG. 5 the GH bit, in accordance with an embodiment of the invention, enables the debugger under control of a programmer to institute breakpoint debugging.

In block 502, the debugger sets GH equal to one in global control register 206 to signify that the current instruction being executed by PE 202A is to be halted. As noted above with respect to the embodiment of FIG. 4, and in the discussion which follows, the invention is not limited with respect to how the logical state of the control bits such as the GH bit are defined. While in the embodiment of FIG. 5 the logical state of GH indicating a halt of the current instruction is a logical one, in another embodiment the halt condition is indicated by GH equal to zero, for example. Returning to the embodiment of FIG. 5, in block 504 the debugger then sets SH equal to zero to halt execution of the current instruction. With the current instruction halted the programmer can use the debugger to inspect the state of program variables at the point in the program flow immediately prior to the current instruction. In block 506, the debugger finishes execution of the current instruction by resetting GH to equal zero. Setting GH equal to zero has the general function of releasing the current instruction from the halted state represented by block 504. In this manner the invention enables global hardware control of breakpoint assembly code debugging.

FIG. 6 illustrates a flow diagram representing implementation by a debugger program of hardware assisted assembly code debugging using the BH breakpoint halt control bit included in each instruction op-code, in accordance with an embodiment of the invention. In the embodiment of FIG. 6 the BH bit, in accordance with an embodiment of the invention, enables the debugger under control of the programmer to institute breakpoint debugging. In block 602, the debugger sets BH equal to one in an instruction's op-code 302 to signify that when that instruction is the current instruction being executed by PE 202A its execution is to be halted. In block 604, the debugger halts execution of the current instruction as indicated by the setting of BH=1 in block 602 by setting SH equal to zero and GH equal to one within global control register 206. As noted above this places the program being debugged into a halted state thus enabling the programmer to assess program variables as needed. In block 606, the debugger finishes execution of the current instruction by resetting GH equal to zero. In this manner the invention enables instruction specific hardware control of breakpoint assembly code debugging.

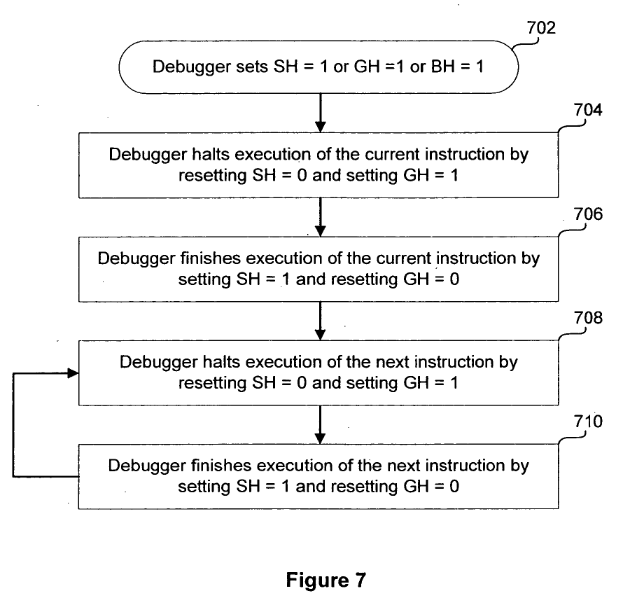

FIG. 7 illustrates a flow diagram representing implementation by a debugger program of hardware assisted assembly code debugging using the SH step halt control bit, in accordance with an embodiment of the invention. In the embodiment of FIG. 7 the SH bit, in accordance with an embodiment of the invention, enables the debugger under control of the programmer to institute single-stepping debugging. In block 702, the debugger sets either SH or GH equal to one in global control register 206 to signify that PE 202A should halt execution of the current instruction or sets BH=1 in an instruction to signify that the instruction should be halted when it becomes the current instruction. In block 704, the debugger halts execution of the current instruction by setting SH equal to zero and GH equal to one within global control register 206. As noted above this places the program being debugged into a halted state thus enabling the programmer to assess program variables as needed. In block 706, the debugger finishes execution of the current instruction by resetting GH equal to zero while also indicating that the subsequent or next instruction is to be halted by resetting SH equal to one. In block 708, the debugger halts execution of the subsequent or next instruction by again setting SH equal to zero and GH equal to one within global control register 206. In block 710, the debugger finishes execution of the next instruction by resetting GH equal to zero and indicates that the subsequent instruction in the program flow is to be halted by resetting SH equal to one and the debugger returns to block 708. As long as the programmer controlling the debugger wishes to continue single-stepping through the program being debugged the programmer configures the debugger to loop between blocks 708 and 710. In this manner the invention enables hardware control of single-stepping assembly code debugging.

Thus, methods, apparatuses and systems for hardware assisted assembly code debugging have been described. Although the invention has been described with reference to specific exemplary embodiments, it will be evident that various modifications and changes may be made to these embodiments without departing from the broader spirit and scope of the invention. For example, while the operations are described in reference to debugging of programs executing on a media processor, in other embodiments, such operations are applicable to other types of processors. Therefore, the specification and drawings are to be regarded in an illustrative rather than a restrictive sense.

1. A method comprising:
setting a first indicator; and
interrupting execution of a computer program instruction in response to setting the first indicator.

2. The method of claim 1, further comprising:
setting a second indicator; and
halting execution of the computer program instruction in response to setting the first and second indicators.

3. The method of claim 2, further comprising:
resetting the first indicator; and
resuming execution of the computer program instruction in response to resetting the first indicator.

4. The method of claim 2, wherein the first and second indicators comprise data bits.

5. The method of claim 4, wherein the data bits are held in a register.

6. The method of claim 1, further comprising:
setting a second indicator;
setting a third indicator; and
halting execution of the computer program instruction in response to setting the second and third indicators.

7. The method of claim 6, further comprising:
resetting the third indicator; and
resuming execution of the computer program instruction in response to resetting the third indicator.

8. The method of claim 6, wherein the computer program instruction includes the first indicator.

9. The method of claim 6, wherein the second and third indicators comprise data bits.

10. The method of claim 9, wherein the data bits are held in a register.

11. The method of claim 1, further comprising:
resetting the first indicator;
setting a second indicator; and
halting execution of the computer program instruction in response to resetting the first indicator and setting the second indicator.

12. The method of claim 11, further comprising:
resetting the second indicator; and
resuming execution of the computer program instruction in response to resetting the second indicator.

13. The method of claim 11, further comprising:
setting the first indicator;
resetting the second indicator;
resuming execution of the computer program instruction in response to setting the first indicator and to resetting the second indicator; and
interrupting execution of a subsequent computer program instruction in response to setting the first indicator and to resetting the second indicator.

14. The method of claim 13, further comprising:
resetting the first indicator;
setting the second indicator; and
halting execution of the subsequent computer program instruction in response to resetting the first indicator and to setting the second indicator.

15. The method of claim 11, wherein the first and second indicators comprise data bits.

16. The method of claim 15, wherein the data bits are held in a register.

17. An apparatus comprising:
a processor; and
at least one indicator coupled to the processor, wherein the at least one indicator is configurable to halt execution of a computer program instruction by the processor.

18. The apparatus of claim 17, wherein the at least one indicator comprises at least one data bit readable by the processor.

19. The apparatus of claim 18, wherein the at least one data bit is held in a register coupled to the processor.

20. The apparatus of claim 17, wherein the computer program instruction executed by the processor includes at least one indicator configurable to interrupt execution of the computer program instruction.

21. The apparatus of claim 20, wherein the at least one indicator included in the computer instruction comprises at least one data bit.

22. The apparatus of claim 17 wherein the at least one indicator is reconfigurable to resume execution of the computer program instruction.

23. The apparatus of claim 17 wherein the at least one indicator is reconfigurable to resume execution of the computer program instruction and to halt execution of a subsequent computer program by the processor.

24. A machine-readable medium that provides instructions, which when executed by a machine, cause said machine to perform operations comprising:
configuring at least one indicator coupled to a processor;
halting execution by the processor of an instruction issued by a computer program in response to the configuring of the at least one indicator;
reconfiguring the at least one indicator; and
finishing execution by the processor of the instruction issued by the computer program in response to the reconfiguring of the at least one indicator.

25. The machine-readable medium of claim 24, wherein the at least one indicator comprises at least one data bit.

26. The machine-readable medium of claim 25, wherein the at least one data bit is held in a register coupled to the processor.

27. The machine-readable medium of claim 24, wherein the at least one indicator comprises at least one indicator included in the computer program instruction, wherein the at least one indicator included in the computer program instruction is configurable to interrupt execution of the computer program instruction.

28. The machine-readable medium of claim 27, wherein the at least one indicator included in the computer program instruction comprises at least one data bit.

29. The machine-readable medium of claim 24, wherein reconfiguring the at least one indicator causes the processor to halt execution of a subsequent computer program instruction.

30. A system comprising:
a processor to execute computer program instructions;
a memory coupled to the processor, the memory to store the computer program instructions to be executed by the processor; and
at least one indicator coupled to the processor, the at least one indicator configurable to control execution of the computer program instructions by the processor.

31. The system of claim 30, wherein the at least one indicator comprise at least one data bit configurable to halt execution of one or more of the computer program instructions by the processor.

32. The system of claim 31, wherein the at least one data bit is reconfigurable to resume execution of the one or more of the computer program instructions by the processor.

33. The system of claim 30, wherein the at least one indicator comprises at least one data bit.

34. The system of claim 33, wherein the at least one data bit is held in a register.

35. The system of claim 30, wherein the at least one indicator comprises at least one indicator included in the computer program instruction, wherein the at least one indicator included in the computer program instruction is configurable to interrupt execution of the computer program instruction.

36. The system of claim 35, wherein the at least one indicator included in the computer program instruction comprises at least one data bit.

37. An apparatus comprising:
at least one indicator configurable to halt execution of a computer program instruction by embedded logic.

38. The apparatus of claim 37, wherein the at least one indicator is at least one data bit readable by embedded logic.

39. The apparatus of claim 38, wherein the at least one data bit is held in a register.

40. The apparatus of claim 37, wherein the computer program instruction executable by embedded logic includes at least one indicator configurable to interrupt execution of the computer program instruction.

41. The apparatus of claim 40, wherein the at least one indicator included in the computer instruction comprises at least one data bit.

42. The apparatus of claim 37, wherein the at least one indicator is reconfigurable to resume execution of the computer program instruction.

43. The apparatus of claim 37, wherein the at least one indicator is reconfigurable to resume execution of the computer program instruction and to halt execution of a subsequent computer program.

44. A machine-readable medium that provides instructions, which when executed by a machine, cause said machine to perform operations comprising:
configuring at least one indicator readable by embedded logic;
halting execution by embedded logic of an instruction issued by a computer program in response to the configuring of the at least one indicator;
reconfiguring the at least one indicator; and
finishing execution by embedded logic of the computer program instruction in response to the reconfiguring of the at least one indicator.

45. The machine-readable medium of claim 44, wherein the at least one indicator comprises at least one data bit.

46. The machine-readable medium of claim 45, wherein the at least one data bit is held in a register.

47. The machine-readable medium of claim 44, wherein the at least one indicator comprises at least one indicator included in the computer program instruction, wherein the at least one indicator included in the computer program instruction is configurable to interrupt execution of the instruction.

48. The machine-readable medium of claim 47, wherein the at least one indicator included in the computer program instruction comprises at least one data bit.

49. The machine-readable medium of claim 44, wherein embedded logic halts execution of a subsequent computer program instruction in response to reconfiguring the at least one indicator.

50. A system comprising:
computer program instructions executable by embedded logic;
a memory to store the computer program instructions; and
at least one indicator configurable to control execution of the computer program instructions.

51. The system of claim 50, wherein the at least one indicator comprises at least one data bit configurable to halt execution of one or more of the computer program instructions.

52. The system of claim 51, wherein the at least one data bit is reconfigurable to resume execution of the one or more of the computer program instructions.

53. The system of claim 50, wherein the at least one indicator comprises at least one indicator included in the computer program instruction, wherein the at least one indicator included in the computer program instruction is configurable to interrupt execution of the instruction.

54. The system of claim 53, wherein the at least one indicator included in the computer program instruction comprises at least one data bit.

55. The system of claim 50, wherein at least one indicator comprises at least one data bit.

56. The system of claim 55, wherein the at least one data bit is held in a register.
